(19) United States
(12) Patent Application Publication
(10) Pub. No.: US 2012/0058258 A1
(43) Pub. Date: Mar. 8, 2012

(54) METHODS OF CLEANING HARD DRIVE DISK SUBSTRATES FOR NANOIMPRINT LITHOGRAPHY

(75) Inventors: Zhengmao Ye, Austin, TX (US); Rick Ramos, El Paso, TX (US)

(73) Assignee: MOLECULAR IMPRINTS, INC., Austin, TX (US)

(21) Appl. No.: 13/227,205

(22) Filed: Sep. 7, 2011

Related U.S. Application Data
(60) Provisional application No. 61/380,410, filed on Sep. 7, 2010.

(51) Int. Cl. G11B 5/84; B08B 1/00; B05D 3/12; B05D 3/10; B05D 3/00; B08B 3/12; B08B 3/08

(52) U.S. Cl. 427/127; 134/1

(57) ABSTRACT

Post sputter cleaning of hard disk substrates for use in an imprint lithography processes. The cleaning removes contaminants including organic contaminants that otherwise may cause repeating void (non-fill) defects in the imprinted pattern.

### CROSS-REFERENCE TO RELATED APPLICATION

This application claims priority to U.S. application Ser. No. 61/380,410 filed Sep. 7, 2010, which is incorporated by reference herein in its entirety.

### BACKGROUND

Nano-fabrication includes the fabrication of very small structures that have features on the order of 100 nanometers or smaller. One application in which nano-fabrication has had a sizeable impact is in the patterning of hard disk drives. The hard disk industry continues striving to increase the storage density on a disk, and forming patterning boundaries between magnetic domains (so-called “patterned media”) using nano-fabrication techniques can increase such densities. Therefore nano-fabrication has become increasingly important in the hard disk industry. Nano-fabrication also provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference herein.

An imprint lithography technique disclosed in each of the aforementioned U.S. patent publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that features and advantages of the present invention can be understood in detail, a more particular description of embodiments of the invention may be had by reference to the embodiments illustrated in the appended drawings. It is to be noted, however, that the appended drawings only illustrate typical embodiments of the invention, and are therefore not to be considered limiting of its scope, for the invention may admit to other equally effective embodiments.

FIG. 1 illustrates a simplified side view of a lithographic system.

FIG. 2 illustrates a simplified side view of the substrate illustrated in FIG. 1, having a patterned layer thereon.

FIG. 3 illustrates a flow chart of a method for surface cleaning preparation of the substrate in FIGS. 1 and 2.

FIGS. 4A and 4B show images of imprinted disk on contaminated substrates.

FIG. 5 shows an image of an imprinted disk on a substrate cleaned according to the method illustrated in FIG. 3.

### DETAILED DESCRIPTION

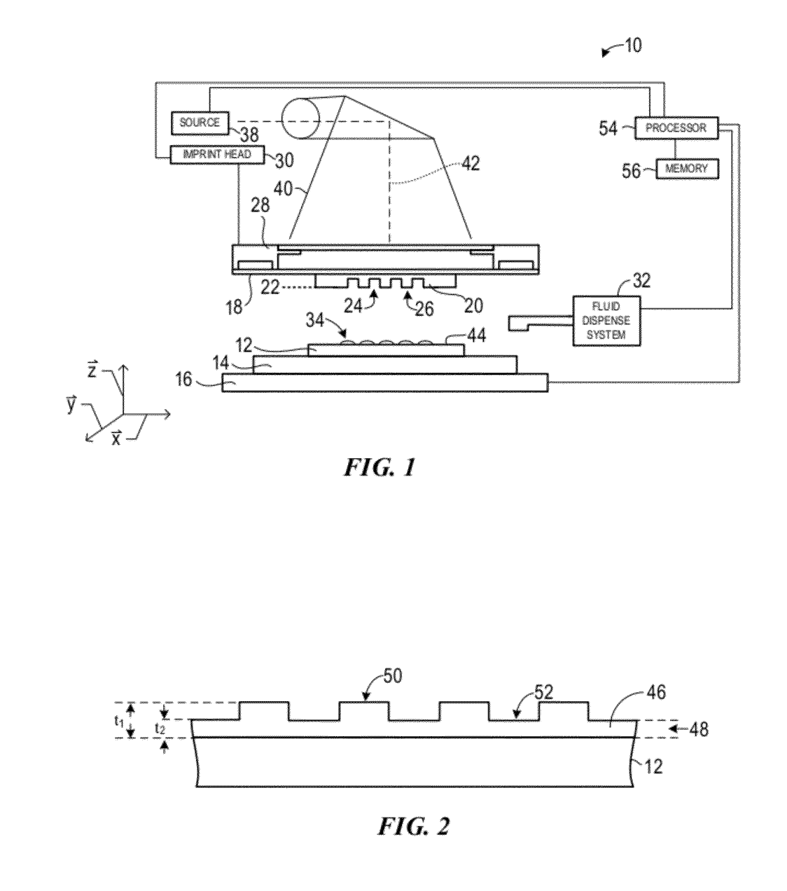

Referring to the figures, and particularly to FIG. 1, illustrated therein is a lithographic system 10 used to form a relief pattern on substrate 12, such as a disk substrate for use in hard drive applications. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electrostatic, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide translational and/or rotational motion along the x, y, and z-axes. Stage 16, substrate 12, and substrate chuck 14 may also be positioned on a base (not shown).

Spaced-apart from substrate 12 is template 18. Template 18 may include a body having a first side and a second side with one side having a mesa 20 extending therefrom towards substrate 12. Mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations (e.g., planar surface). Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electrostatic, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit formable material 34 (e.g., polymerizable material) on substrate 12. Formable material 34 may be positioned upon substrate 12 using techniques, such as, drop dispense, spin-coating, dip coating, chemical vapor deposition (CVD), physical vapor deposition (PVD), thin film deposition, thick film deposition, and/or the like. Formable material 34 may be disposed upon substrate 12 before and/or after a desired volume is defined between mold 22 and substrate 12 depending on design considerations. For example, formable material 34 may comprise a monomer mixture as described in U.S. Pat. No. 7,157,036 and U.S. Patent Publication No. 2005/0187339, both of which are herein incorporated by reference. Referring to FIGS. 1 and 2, system 10 may further comprise energy source 38 coupled to direct energy 40 along path 42. Imprint head 30 and stage 16 may be configured to position template 18 and substrate 12 in superimposition with path 42. System 10 may be regulated by processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by formable material 34. For example, imprint head 30 may apply a force to template 18 such that mold 20 contacts formable material 34. After the desired volume is filled with formable material 34, source 38 produces energy 40, e.g., ultraviolet radiation, causing formable material 34 to solidify and/or cross-link conforming to a shape of surface 44 of substrate 12 and patterning surface 22, defining patterned layer 46 on substrate 12. Patterned layer 46 may comprise a residual layer 48 and a plurality of features shown as protrusions 50 and recessions 52, with protrusions 50 having a thickness t₁ and residual layer having a thickness t₂.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. No. 7,396,475, all of which are hereby incorporated by reference in their entirety.

Effective nanoimprint lithography processes require full template and substrate conformity during the imprint process to achieve high feature fidelity pattern transfer. Without adequate substrate surface cleaning preparation, the methods as described in relation to FIGS. 1 and 2 may encounter a number of defects. For example, a particle on the disk surface during the imprinting process can negatively interfere with the pattern transfer resulting in feature distortion (e.g. distortion of features 50 and 52). In addition, hard particles may result in permanent damage to the imprint template 18. Additionally, organic compounds, e.g., siloxane and isopropyl alcohol (IPA), etc., on the substrates can change the resist spread behavior and result in void defects in the imprint area that are due to a lack of resist (non-fill), especially in the interstitial area of the imprint resist drops. These void defects may be caused by picoliter droplets of polymerizable material 34 that do not fully merge during the imprinting process due to the presence of such contaminants. Traces of such organic compounds can be easily found in the air of the manufacture environment and contaminate the substrate surfaces. It is crucial to remove these contaminations prior to the imprint process. Organic contaminated substrates may also impact fluid spreading interfering with wetting characteristics of the imprint fluid.

In hard disk drive industrial processes, typically there is no substrate cleaning process used for cleaning disks post-sputter. This allows for large and/or hard particles to collect on the disk substrate and lead to imprint defects and damage to the template in subsequent imprint lithography patterning steps. An effective post-sputter disk cleaning process can therefore be important for both high fidelity pattern transfer and prevention of damage to the imprint template. Further, existing disk cleaning process used prior to sputtering are also inadequate to remove such particles. The hard drive disk substrate cleaning processes described herein effectively remove and avoid particle contamination to meet the imprint requirements.

Conventional disk cleaning processes for bare disk surfaces typically utilize deionized (DI) water and detergent, which is not an effective cleaning method for both particle and organic contamination removal on substrate. In the present invention, SC-1 chemistry is introduced to greatly enhance the particle and contamination removal efficiency in order to meet the requirements of nanoimprint processes. As used herein, SC-1 or SC-1 solution refers to an alkaline cleaning solution of deionized (DI) water, ammonium hydroxide (NH₄OH), and hydrogen peroxide (H₂O₂). Typical concentrations used are 29% and 30% by weight for NH₄OH and H₂O₂, respectively. Typical mixing ratios of the solution components are 1:1:50 to 1:1:100 (NH₄OH:H₂O₂:DI) are used, depending on the cleaning tool. At the pH level of the alkaline SC-1 solution the disk surface becomes negatively charged along with the removed particle. These electrostatic charges create a potential difference between the disk and removed particle also known as the zeta potential. The zeta-potential is desirable because it creates a repulsion effect between the disk surface and removed particle that prevents particle re-deposition. The alkaline SC-1 solution can also oxidize organic contaminants, aiding in their removal.

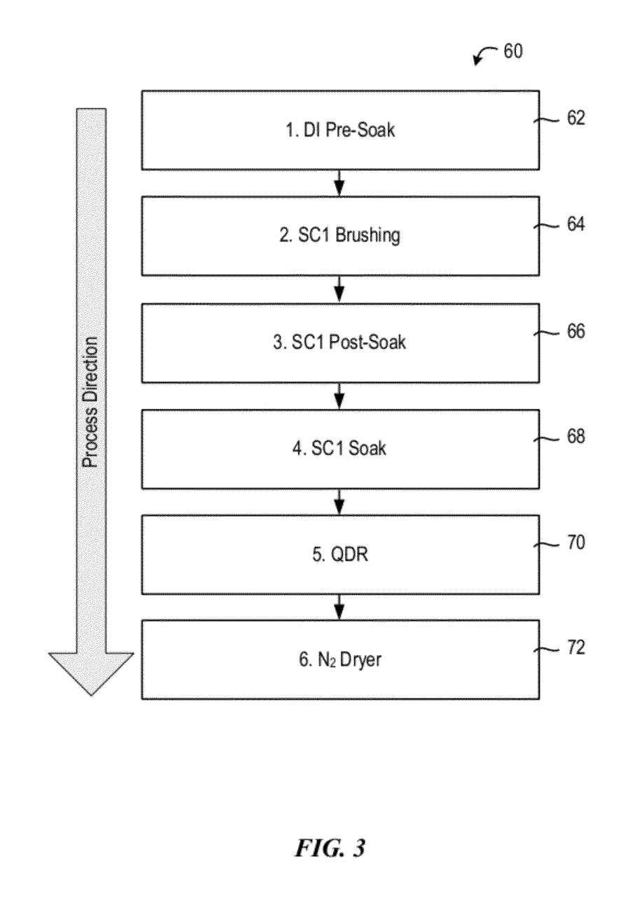

FIG. 3 illustrates an exemplary flow chart 60 of a method for surface cleaning preparation of disk substrate 12 for a nanoimprint lithography process as described in relation to FIGS. 1 and 2. Generally, the method includes a pre-soak, followed by a brush clean, and post soak with sonication and cascade liquid flow. This may be followed by a quick dump rinse and a hot N₂ dry. An SC-1 solution can be used in both brushing and sonication steps. The combination of SC-1 chemistry with brushing and sonication may prepare the surface of substrate 12 for a nanoimprint lithography process as described in relation to FIGS. 1 and 2. Preparation may clean substrate 12 of both particulate and organic contamination. The method is provided as a post-sputter cleaning process.

Referring to FIG. 3, in a step 62, substrate 12 may be pre-soaked. Pre-soaking may be in deionized water or SC-1 solution. Pre-soaking may provided within a tank capable of full wetting of the surface of substrate 12. In a step 64, substrate 12 may be brushed on both sides. SC-1 soaked brushes may be used in brushing of one or both surfaces of substrate 12. In a step 66, substrate 12 may be positioned in a first SC-1 post brushing soak tank. The soak tank may include sonication. In a step 68, substrate 12 may be positioned in a second SC-1 soak tank. The soak tank may include sonication and/or cascade flow. In a step 70, substrate 12 may be rinsed in deionized water (i.e., quick dump rinse). In a step 72, substrate 12 may be dried. Drying may be through the use of an N₂ dryer (e.g., hot N₂ dryer).

### EXAMPLES

The examples below describe embodiments of the cleaning process used to prepare a hard disk substrate surface for pattern transfer through nanoimprint lithography, using two different disk cleaners. All cleaning processes and evaluations were conducted on 65 mm glass disks with a 40 nm Ta coating.

### Example 1

### SSEC Clean Process

A modified SSEC single wafer cleaner (Horsham, Pa., USA) was initially used for disk cleaning using SC-1 chemistry. The SSEC cleaner uses a dual module cleaning process that includes a brushing and spin module. The brushing module is equipped with PVA brushes and a spray-bar. The spin module is equipped with a PVA brush for front-side brushing, front-side high-velocity SC-1 spray, dual side DI water rinse, and front-side N2 assisted spin dry.

The brushing module process begins with 60 sec of dual-side PVA brushing with SC-1 solution at a brush rotation of 250 rpm. This is followed up with 140 sec of dual-side PVA brushing with DI water at a brush rotation of 250 rpm that includes front-side DI water spraying from a spray-bar. The PVA brush spacing is pressure-controlled and set at the point where the brush nodules make light contact with the disk surface. At the completion of the DI water brushing and spraying the disk is transferred to the spin module.

The spin module process begins with 20 sec of front-side PVA brushing of the disk surface with SC-1 solution. The brush pressure is again set at the point where the nodules are in light contact with the disk surface with a brush rotation speed of 250 rpm. High-velocity nitrogen atomized SC-1 spray of the front-side of the disk surface follows the PVA brushing. This is a 15 sec process step where the high-velocity spray arm oscillates across the front-side of the disk surface. Completing the spin module process is a 30 sec rinse that uses front and back-side DI water streams followed by a front-side N2 assisted drying at a disk rotation speed of 2000 rpm. A summary of the entire SSEC clean process recipe is contained in Table 1.

TABLE 1
SSEC clean process

| | | Disk | Brush | |
|---|---|---|---|---|
| Step | Process Step | RPM | RPM | Chemistry |
| 1 | SC-1 Brushing | na | 250 | SC-1 (1:1:50) |
| 2 | DI Brushing | na | 250 | 18 MΩ H₂O |
| 3 | SC-1 Brushing | 100 | 250 | SC-1 (1:1:50) |
| 4 | SC-1 HVS | 100 | na | SC-1 (1:1:50) |
| 5 | DI Rinse | 1500 | na | 18 MΩ H₂O |
| 6 | N₂ Dry | 2000 | na | N₂ |

The disk cleaning process was evaluated using a Candela 6120 manufactured by KLA-Tencor (Milpitas, Calif., USA). A particle scan recipe was setup for a bare Ta coated disk that categorized particles into two bins; >300 nm and <300 nm calibrated with polystyrene latex spheres. Particles were detected down to 90 nm with the Candela 6120.

SSEC post clean disk scan results yield less than 1 particle >300 nm and less than 35 particles <300 nm. See Table 2. Particles <300 nm also show a large dependency on the incoming particle count. Particle removal efficiencies of particles <300 nm was ˜50% while removal efficiencies of particles >300 nm was above 95%.

TABLE 2
Disk particle counts post SSEC clean

| | Particles | Particles |
|---|---|---|
| Disk | (>300 nm) | (<300 nm) |
| 02B | 0 | 51 |
| 03B | 0 | 32 |
| 06B | 0 | 31 |
| 09B | 1 | 39 |
| 12B | 0 | 14 |
| 15B | 0 | 38 |
| 18B | 0 | 36 |
| 21B | 1 | 26 |
| 23B | 1 | 52 |
| 24B | 0 | 24 |
| Avg | 0.3 | 34.3 |

### Example 2

### Invenpro Clean Process

A dedicated disk cleaner manufactured by Invenpro (Selangor Darul Ehsan, Malaysia) installed and characterized for high throughput disk cleaning up to 600 dph was used in this example. This cleaner contains 4 process modules; brushing, tunnel flow; quick dump rinse, and N2 drying. All process modules are full cassette batch processes with the exception of the brushing module which is single disk processing.

The brushing module process begins with a 40 sec DI water bath pre-soak tank for full disk surface wetting. The disks are then individually brushed both on the front and back-side with PVA brushes using SC-1 chemistry. Each disk receives a total brushing time of 20 sec at a brush rotation speed of 250 rpm. Once brushing of the disk is complete it is loaded into a post soak tank with SC-1 chemistry where all 25 disks load into a single boat. After all disks have been loaded to the post soak tank sonication is added at a frequency of 120 kHz for 150 sec. Disks are then transferred to the tunnel flow module.

The tunnel flow module consists of a single bath with SC-1 chemistry that has cascade liquid flow and sonication. Total tunnel flow process time is 150 sec that consists of 60 sec of 270 kHz sonication followed by 60 sec of 1.3 MHz sonication and completes with 30 sec sweeping sonication at frequencies of 430 kHz and 1.3 MHz. Disks are then transferred to the quick dump rinse module.

The quick dump rinse module uses DI water only. Disks are loaded into a DI water tank for a 3 sec soak. The DI water tank is dumped in ˜0.5 sec upon which DI water spray bars are tuned on for 5 sec. The tank is then refilled with fresh DI water in 2 sec during which time the spray bars remain on. This cycle is repeated 7 times. Disks are then transferred to the drying module.

The drying module process begins with disks being loaded into a continuous overflow DI water tank. Disks are then pulled slowly out of the water bath while heated N2 is purged perpendicular to the liquid surface. The heated N2 enhances the ability to use the surface tension of the water as the drying mechanism; this combined with the slow rate at which the disks are pulled out of the water bath results in a dry disk surface with no drying marks. The Invenpro cleaning process is summarized in Table 3.

TABLE 3
Invenpro clean process

| Step | Process Step | Sonication (kHz) | Chemistry |
|---|---|---|---|
| 1 | DI Pre-soak | na | 18 MΩ H₂O |
| 2 | SC-1 Brushing | na | SC-1 (1:1:50) |
| 3 | SC-1 Post-soak | 120 | SC-1 (1:1:100) |
| 4 | SC-1 Soak | 270, 1300, 430 | SC-1 (1:1:100) |
| 5 | 7 Cycle Rinse | na | 18 MΩ H₂O |
| 6 | N₂ Dry | na | 18 MΩ H₂O/N₂ |

The disk cleaning process was evaluated using the Candela 6120 with a particle scan recipe and particle detection range as described above in Example 1. Invenpro post clean disk scan results yield less than 1 particle >300 nm and less than 16 particles <300 nm. See Table 4. Again, particles <300 nm showed a large dependency on the incoming particle count. Particle removal efficiencies of particles <300 nm was ˜50% while removal efficiencies of particles >300 nm was above 95%.

TABLE 4
Disk particle counts post Invenpro clean

| | Particles | Particles |
|---|---|---|
| Disk | (>300 nm) | (<300 nm) |
| 01B | 0 | 19 |
| 01A | 0 | 19 |
| 07B | 0 | 15 |
| 07A | 0 | 15 |
| 13B | 0 | 14 |
| 13A | 0 | 8 |
| 19B | 0 | 17 |
| 19A | 0 | 21 |
| 25B | 0 | 17 |
| 25A | 1 | 6 |
| Avg | 0.10 | 15.10 |

### Example 3

### Surface Contamination Removal

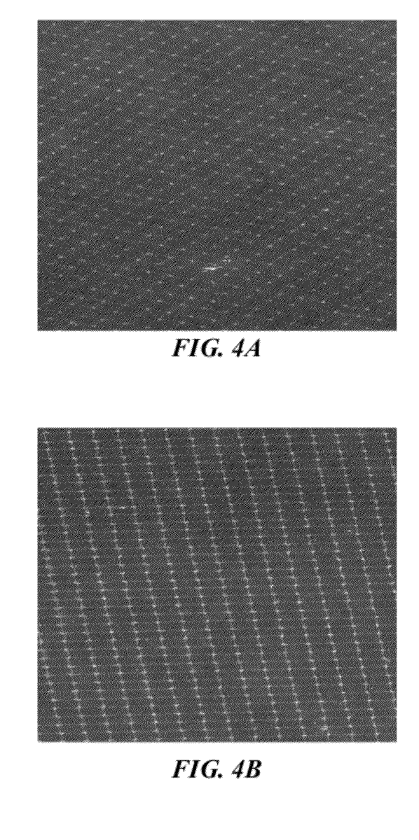

Disk substrates were provide as above (65 mm glass disks with a 40 nm Ta coating) and subjected to cleaning using either a deionized (DI) water and detergent solution or the cleaning process of Example 2. The substrates were then imprinted according to the nanoimprint lithography method described above, with polymerizable material dispensed as picoliter droplets (at approximately 20,000 droplets per disk). The material was cured and images take using the KLA-Tencor Candela 6120. FIGS. 4A and 4B show images of imprinted substrates that were cleaned using the DI/detergent solution. The FIG. 4A image shows a grid pattern (white dots), which are indicative of the existence of void (or non-fill) imprint defects attributable to organic contamination of the substrate. Note that particle contamination by contrast produces random, non-repeating defects. Depending on the level of organic contamination, these defect can occur on every imprint drop interstitial area, as show in FIG. 4B, which shows non-fill areas (white dot, extending lines) of a heavily contaminated substrate.

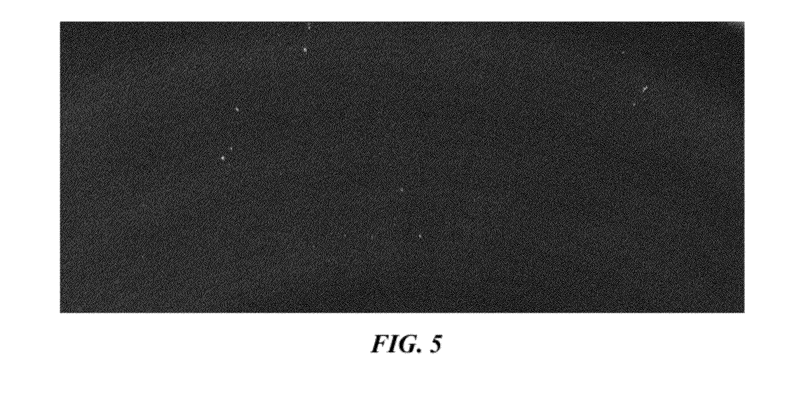

FIG. 5 by contrast shows the results of imprinting a disk substrate as above using the process of Example 2. With this cleaning process, the organic contaminants were effectively removed, eliminating the contamination related non-fill imprint defects seen in FIGS. 4A and 4B.

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A method for cleaning the surface of a hard disk drive substrate, the method comprising the steps of:
providing a hard disk drive substrate;
pre-soaking the substrate in a first cleaning solution;
brushing the substrate in a second cleaning solution; and
soaking the substrate in the second cleaning solution with sonication.

2. The method of claim 1 wherein the provided substrate is sputtered prior to soaking in the first cleaning solution.

3. The method of claim 1 wherein the first cleaning solution is deionized water.

4. The method of claim 1 wherein the second cleaning solution comprises ammonium hydroxide, hydrogen peroxide and water.

5. The method of claim 1 wherein the soaking step further comprises varying the sonication frequency.

6. The method of claim 5 wherein the sonication frequencies range from 120 kHz to 1.3 mHz.

7. The method of claim 1 wherein the soaking the substrate in a second cleaning solution further comprises subjecting the substrate to a cascade flow of the second cleaning solution.

8. The method of claim 1 further comprising rinsing the substrate in deionized water after soaking the substrate in the second cleaning solution.

9. The method of claim 7 further comprising drying the substrate after rinsing the substrate.

10. The method of claim 9 wherein the drying the substrate further comprises drying under a heated nitrogen.

11. A method for cleaning the surface of a hard disk drive substrate, the method comprising the steps of:
providing a hard disk drive substrate;
soaking the substrate in deionized water;
brushing the substrate in a cleaning solution comprising ammonium hydroxide, hydrogen peroxide and water;
soaking the substrate in the cleaning solution with sonication;
rinsing the substrate in deionized water; and
drying the substrate under heated nitrogen.

12. The method of claim 11 wherein the soaking step further comprises varying the sonication frequency.

13. The method of claim 12 wherein the sonication frequencies range from 120 kHz to 1.3 mHz.

14. A method for reducing void defects in a patterned layer imprinted on a hard disk drive substrate, the method comprising the steps of:
providing a hard disk drive substrate;
soaking the substrate in deionized water;
brushing the substrate in a cleaning solution comprising ammonium hydroxide, hydrogen peroxide and water;
soaking the substrate in the cleaning solution with sonication;
rinsing the substrate in deionized water;
drying the substrate;
dispensing a polymerizable material on the substrate;
contacting the polymerizable material with a template having a patterning surface;
solidifying the polymerizable material to form the patterned layer.

15. The method of claim 14 wherein the provided substrate is sputtered prior to soaking in the first cleaning solution.

16. The method of claim 14 wherein the soaking step further comprises varying the sonication frequency.

17. The method of claim 16 wherein the sonication frequencies range from 120 kHz to 1.3 mHz.

18. The method of claim 14 wherein the soaking the substrate further comprises subjecting the substrate to a cascade flow of the cleaning solution.

19. The method of claim 14 wherein the drying the substrate further comprises drying under a heated nitrogen.

20. The method of claim 14 wherein the polymerizable material is deposited on the substrate as a plurality of droplets.
